(19) United States
(12) Patent Application Publication
(10) Pub. No.: US 2016/0207812 A1
(43) Pub. Date: Jul. 21, 2016

(54) SCALE TREATMENT APPARATUS

(71) Applicants: Hong-Jum JOO, Seoul (KR); Jung-Deok KIM, Gwangmyeong-si (KR); HS INNOTECH INC., Bucheon-si (KR)

(72) Inventors: Hong-Jum JOO, Seoul (KR); Jung-Deok KIM, Gwangmyeong-si (KR)

(73) Assignees: HS INNOTECH INC., Bucheon-si (KR); Hong-Jum JOO, Seoul (KR); Jung-Deok KIM, Gwangmyeong-si (KR)

(21) Appl. No.: 15/082,793

(22) Filed: Mar. 28, 2016

Related U.S. Application Data
(63) Continuation of application No. PCT/KR2014/008804, filed on Sep. 23, 2014.

(30) Foreign Application Priority Data
Oct. 31, 2013 (KR) 10-2013-0131491

(51) Int. Cl. C02F 5/02; B08B 9/027

(52) U.S. Cl. CPC C02F 5/02; B08B 9/027; C02F 2101/10

(57) ABSTRACT

Disclosed is a scale treatment apparatus for changing structures of water and various mineral materials in a pipe and supplying activation energy, thereby preventing the accumulation of, as well as removing, amorphous CaCO₃ or sediment in the pipe. This scale treatment apparatus includes: an interrupted direct current supply unit for alternately outputting low-frequency interrupted direct current and high-frequency interrupted direct current at a predetermined time interval; and a magnetic field generation unit provided to the pipe while being connected to the interrupted direct current supply unit such that an intermittently vibrating electromagnetic field is generated by low-frequency interrupted direct current and high-frequency interrupted direct current, which are alternately output from the interrupted direct current supply unit, and is then applied to the pipe, wherein the interrupted direct current supply unit includes a power supply circuit to which direct current power is supplied, a basic frequency oscillation circuit connected to the power supply circuit, a low-frequency oscillation circuit and a high-frequency oscillation circuit, connected to the basic frequency oscillation circuit, an interrupted direct current circuit connected to the low-frequency oscillation circuit and the high-frequency oscillation circuit such that a low frequency emitted from the low-frequency oscillation circuit is converted into low-frequency interrupted direct current and a high frequency emitted from the high-frequency oscillation circuit is converted into high-frequency interrupted direct current, and an alternate output circuit connected to the interrupted direct current circuit such that low-frequency interrupted direct current and high-frequency interrupted direct current, which are applied, are alternately output at a predetermined time interval.

### CROSS REFERENCE TO RELATED APPLICATION

This application is a continuation of PCT/KR2014/008804 filed Sep. 23, 2014 which claims the benefit of Korean Patent Application No. 10-2013-0131491, filed Oct. 31, 2013, the content of each of which is incorporated herein by reference.

### BACKGROUND OF THE INVENTION

1. Field of the Invention

The present invention relates to a scale treatment apparatus and, more particularly, to a scale treatment apparatus, wherein a vibrating magnetic field, created via the alternate application of low-frequency interrupted direct current and high-frequency interrupted direct current, and a magnetic resonance force attributable to the vibrating magnetic field are applied to a pipe, thus changing the structures of water and various mineral materials in the pipe and supplying activation energy, thereby preventing the accumulation of, as well as removing, amorphous CaCO₃ or sediment in the pipe.

2. Background Art

In all places through which a fluid flows, materials such as cations, anions, dissolved oxygen, etc. present in the fluid interact with each other over time, and thus sediment accumulates and corrosion occurs. Such sediment (hereinafter referred to as “scale”) and corrosion act as factors that impede water flow and heat transfer, thus deteriorating the efficiency of operation of the corresponding equipment. In order to prevent or reduce the accumulation of such scale, it is necessary to suppress the interactions between cations and anions or to prevent the oxidation of products.

Moreover, coupling between cations and anions is very natural, and the cation material, from which electrons are lost, and the anion material, which contains more electrons, are coupled with each other through the exchange of the required number of electrons therebetween, thus forming a complete material which is then deposited in a dissolved state. Therefore, the formation of scale in a pipe through which a fluid flows is a very natural phenomenon, but problems attributable to such scale thus formed may occur, ranging from minor problems to major ones.

A variety of techniques are provided to suppress the formation of scale in pipe, and the fundamental principle of such techniques is to supply energy or a material that obstructs the coupling between cations and anions in the pipe.

For example, scale is removed through a sacrificial anode method using zinc or magnesium, or using ultrasonic waves or chemicals.

However, the removal of scale using the sacrificial anode method is problematic because scale forms in the corresponding scale removal apparatus, and thus the area of the contact surface between the apparatus and water is decreased over time, significantly deteriorating the performance of the apparatus.

Also, the removal of scale using ultrasonic waves is difficult to apply to long pipes because the distance to which sound waves have an effect is short. Furthermore, the removal of scale using chemicals is very effective but is disadvantageous because processing costs and secondary environmental pollution are regularly incurred due to the use of consumable chemicals, and thus, this method must be used only in treatment plants having no risk factors.

### SUMMARY OF THE INVENTION

Accordingly, the present invention has been made keeping in mind the above problems encountered in the related art, and an object of the present invention is to provide a scale treatment apparatus, wherein a vibrating magnetic field, created via the alternate application of low-frequency interrupted direct current and high-frequency interrupted direct current, and a magnetic resonance force attributable to the vibrating magnetic field are applied to a pipe, thus changing the structures of water and various mineral materials in the pipe and supplying activation energy, thereby forming CaCO₃ crystals in the pipe and preventing the accumulation of, as well as removing, amorphous CaCO₃ or sediment, which is difficult to remove from the pipe.

### BRIEF DESCRIPTION OF THE DRAWINGS

FIG. 1 is a block diagram illustrating a scale treatment apparatus according to an embodiment of the present invention;

and

FIG. 2 is a block diagram illustrating the detailed configuration of the interrupted direct current supply unit in the scale treatment apparatus according to an embodiment of the present invention.

### DETAILED DESCRIPTION OF THE INVENTION

In order to accomplish the above object, the present invention provides a scale treatment apparatus, comprising: an interrupted direct current supply unit for alternately outputting low-frequency interrupted direct current and high-frequency interrupted direct current at a predetermined time interval; and a magnetic field generation unit provided to the pipe while being connected to the interrupted direct current supply unit such that an intermittently vibrating electromagnetic field is generated by low-frequency interrupted direct current and high-frequency interrupted direct current, which are alternately output from the interrupted direct current supply unit, and is then applied to the pipe.

Also, the interrupted direct current supply unit may include: a power supply circuit to which direct current power is supplied; a basic frequency oscillation circuit connected to the power supply circuit; a low-frequency oscillation circuit connected to the basic frequency oscillation circuit; a high-frequency oscillation circuit connected to the basic frequency oscillation circuit; an interrupted direct current circuit connected to the low-frequency oscillation circuit and the high-frequency oscillation circuit such that a low frequency emitted from the low-frequency oscillation circuit is converted into low-frequency interrupted direct current and a high frequency emitted from the high-frequency oscillation circuit is converted into high-frequency interrupted direct current; and an alternate output circuit connected to the interrupted direct current circuit such that low-frequency interrupted direct current and high-frequency interrupted direct current, which are applied, are alternately output at a predetermined time interval.

Also, the interrupted direct current supply unit may further include: a control circuit provided between the power supply circuit and the basic frequency oscillation circuit such that direct current power of the power supply circuit is variably output in a range from 5V to 15V corresponding to a magnitude of interrupted direct current for a diameter of the pipe; and an output circuit for applying low-frequency interrupted direct current and high-frequency interrupted direct current, which are alternately output from the alternate output circuit, to the magnetic field generation unit.

Also, the output circuit may alternately apply low-frequency interrupted direct current and high-frequency interrupted direct current, each ranging from 1 to 3 (A), to the magnetic field generation unit.

Also, the low-frequency oscillation circuit may oscillate with a sawtooth waveform at a low frequency of 60 to 100 Hz, and the high-frequency oscillation circuit may oscillate at a high frequency of 5 to 10 KHz.

Also, the alternate output circuit may alternately output low-frequency interrupted direct current and high-frequency interrupted direct current at an interval of 1 to 3 sec.

Also, the magnetic field generation unit may include a magnetic field generation coil wound around an outer surface of the pipe so that low-frequency interrupted direct current and high-frequency interrupted direct current are alternately applied from the interrupted direct current supply unit.

Also, the magnetic field generation coil may be configured such that a heat-resistant insulation line is wound 20 to 28 times around the outer surface of the pipe.

Also, the magnetic field generation unit may further include a fixed magnet which is fixedly provided on the outer surface of the pipe so that a fixed magnetic field is applied to the pipe.

Also, the magnetic field generation unit may be provided to the pipe in a manner in which the fixed magnet is disposed between a pair of magnetic field generation coils.

### Advantageous Effects

According to the present invention, the scale treatment apparatus is configured such that a vibrating magnetic field, created via the alternate application of low-frequency interrupted direct current and high-frequency interrupted direct current, and a magnetic resonance force attributable to the vibrating magnetic field are applied to a pipe, thus changing the structures of water and various mineral materials in the pipe and supplying activation energy, thereby forming CaCO₃ crystals in the pipe and preventing the accumulation of, as well as removing, amorphous CaCO₃ or sediment, which is difficult to remove from the pipe.

### Best Mode

Hereinafter, a detailed description will be given of a scale treatment apparatus according to an embodiment of the present invention with reference to the appended drawings.

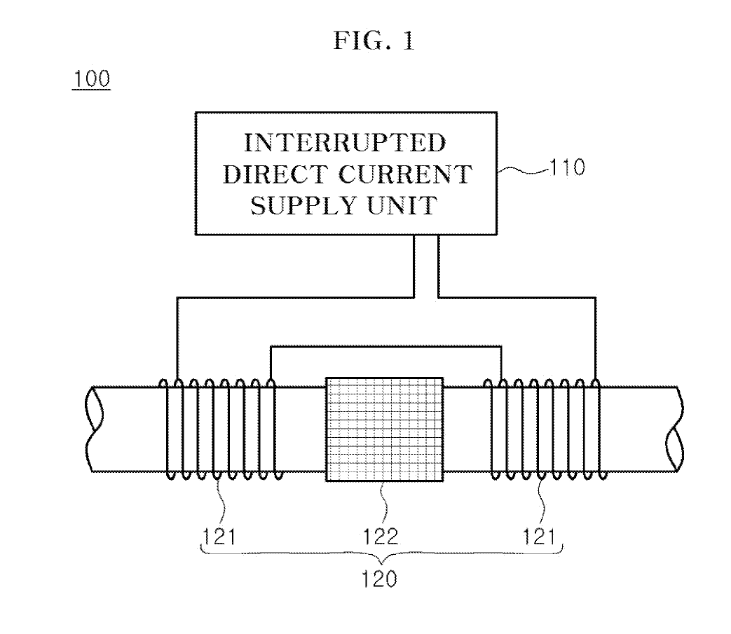

FIG. 1 is a block diagram illustrating a scale treatment apparatus according to an embodiment of the present invention.

As illustrated in FIG. 1, the scale treatment apparatus 100 according to an embodiment of the present invention includes an interrupted direct current supply unit 110 and a magnetic field generation unit 120.

The interrupted direct current supply unit 110 functions to alternately output low-frequency interrupted direct current and high-frequency interrupted direct current at a predetermined time interval.

The magnetic field generation unit 120 is provided on the outer surface of the pipe 200 while being connected to the interrupted direct current supply unit 110. Low-frequency interrupted current and high-frequency interrupted current, which are alternately output from the interrupted direct current supply unit 110, are supplied to the magnetic field generation unit 120. Thus, the magnetic field generation unit 120 functions to generate an intermittently vibrating electromagnetic field which is then applied to the pipe 200.

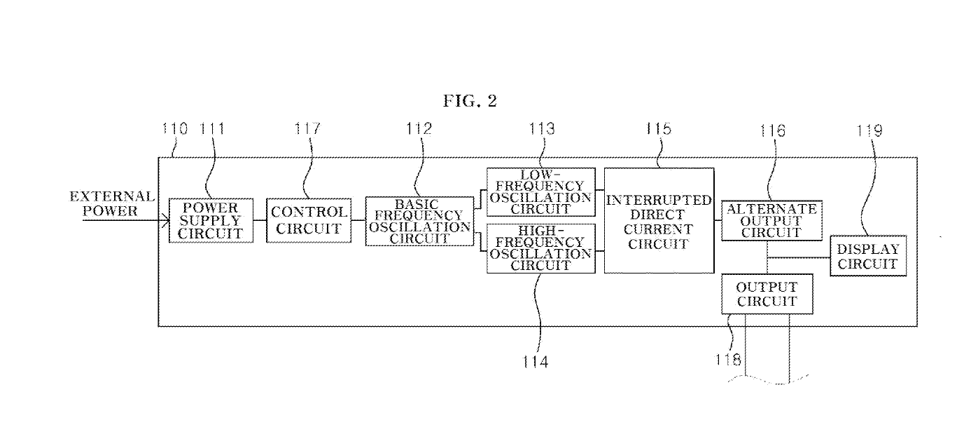

The detailed configuration of the interrupted direct current supply unit 110 is described with reference to FIG. 2.

FIG. 2 is a block diagram illustrating the detailed configuration of the interrupted direct current supply unit in the scale treatment apparatus according to an embodiment of the present invention.

As illustrated in FIG. 2, the interrupted direct current supply unit 110 may include a power supply circuit 111, a basic frequency oscillation circuit 112, a low-frequency oscillation circuit 113, a high-frequency oscillation circuit 114, an interrupted direct current circuit 115, and an alternate output circuit 116. Also, the interrupted direct current supply unit 110 may further include a control circuit 117, an output circuit 118, and a display circuit 119.

External direct current power is supplied to the power supply circuit 111, and the basic frequency oscillation circuit 112 is connected to the power supply circuit 111 so as to oscillate at the basic frequency. The low-frequency oscillation circuit 113 and the high-frequency oscillation circuit 114 are connected to the basic frequency oscillation circuit 112, and the low-frequency oscillation circuit 113 oscillates at a low frequency and the high-frequency oscillation circuit 114 oscillates at a high frequency. In the present embodiment, the low-frequency oscillation circuit 113 oscillates with a sawtooth waveform at a low frequency of 60 to 100 Hz, and the high-frequency oscillation circuit 114 oscillates at a high frequency of 5 to 10 KHz, but the present invention is not limited thereto.

The interrupted direct current circuit 115 is connected to the low-frequency oscillation circuit 113 and the high-frequency oscillation circuit 114, and the interrupted direct current circuit 115 functions to convert the low frequency, emitted from the low-frequency oscillation circuit 113, into low-frequency interrupted direct current, and to convert the high frequency, emitted from the high-frequency oscillation circuit 114, into high-frequency interrupted direct current. Also, the alternate output circuit 116 is connected to the interrupted direct current circuit 115 so that low-frequency interrupted direct current and high-frequency interrupted direct current, which are applied, are alternately output at a predetermined time interval. In an exemplary embodiment of the present invention, low-frequency interrupted direct current and high-frequency interrupted direct current are alternately output at an interval of 1 to 3 sec by the alternate output circuit 116, but the present invention is not limited thereto.

The control circuit 117 is provided between the power supply circuit 111 and the basic frequency oscillation circuit 112, and the control circuit 117 functions such that the direct current power of the power supply circuit 111 is variably output in the range from 5V to 15V corresponding to the magnitude of the interrupted direct current for the diameter of the pipe 200. Also, the output circuit 118 functions to apply low-frequency interrupted direct current and high-frequency interrupted direct current, which are alternately output by the alternate output circuit 116, to the magnetic field generation unit 120. In the present embodiment, low-frequency interrupted direct current and high-frequency interrupted direct current, each ranging from 1 to 3 A, are alternately applied to the magnetic field generation unit 120 by the output circuit 118, but the present invention is not limited thereto.

The display circuit 119 functions to display the current of a power supply LED and a direct current meter, so that abnormalities of the scale removal apparatus, such as disconnection or shorting of coils, may be displayed to the outside. Thus, such a display circuit 119 may include a display unit such as an alarm, etc.

Back to FIG. 1, the magnetic field generation unit 120 includes a magnetic field generation coil 121 that is wound around the outer surface of the pipe 200 so that low-frequency interrupted direct current and high-frequency interrupted direct current are alternately applied from the interrupted direct current supply unit 110. As such, the magnetic field generation coil 121 may be formed such that a heat-resistant insulation line is wound 20 to 28 times around the outer surface of the pipe 200. In the present embodiment, the magnetic field generation coil 121 made of such a heat-resistant insulation line is wound 24 times around the outer surface of the pipe 200.

Also, the magnetic field generation unit 120 may further include a fixed magnet 122 that is fixedly provided to the outer surface of the pipe 200 to apply a fixed magnetic field to the corresponding pipe 200.

The magnetic field generation coil 121 and the fixed magnet 122, which constitute the magnetic field generation unit 120, may be provided to the pipe 200 in a manner in which the fixed magnet 122 is disposed between a pair of magnetic field generation coils 121.

In this configuration, a vibrating magnetic field, created via the alternate application of low-frequency interrupted direct current and high-frequency interrupted direct current, and a magnetic resonance force attributable to the vibrating magnetic field are applied to the pipe, thus changing the structures of water and various mineral materials in the pipe and supplying activation energy. Thereby, CaCO₃ crystals are formed in the pipe, and amorphous CaCO₃ or sediment, which is difficult to remove from the pipe, may be prevented from accumulating and may be removed.

Additionally, the distance between ions in the fluid in the pipe is increased due to the magnetic resonance force of the intermittently vibrating electromagnetic field applied to the pipe, thus intensively enhancing the dispersion of ions, thereby preventing the accumulation of, as well as removing, amorphous CaCO₃ or sediment, which is difficult to remove from the pipe.

Although the preferred embodiments of the present invention regarding the scale treatment apparatus have been disclosed for illustrative purposes, those skilled in the art will appreciate that various modifications, additions and substitutions are possible, without departing from the scope and spirit of the invention as disclosed in the accompanying claims.

The present invention can be widely applied to scale treatment in pipes.

1. A scale treatment apparatus, comprising:
an interrupted direct current supply unit for alternately outputting low-frequency interrupted direct current and high-frequency interrupted direct current at a predetermined time interval; and
a magnetic field generation unit provided to the pipe while being connected to the interrupted direct current supply unit such that an intermittently vibrating electromagnetic field is generated by low-frequency interrupted direct current and high-frequency interrupted direct current, which are alternately output from the interrupted direct current supply unit, and is then applied to the pipe.

2. The scale treatment apparatus of claim 1, wherein the interrupted direct current supply unit comprises:
a power supply circuit to which direct current power is supplied;
a basic frequency oscillation circuit connected to the power supply circuit;
a low-frequency oscillation circuit connected to the basic frequency oscillation circuit;
a high-frequency oscillation circuit connected to the basic frequency oscillation circuit;
an interrupted direct current circuit connected to the low-frequency oscillation circuit and the high-frequency oscillation circuit such that a low frequency emitted from the low-frequency oscillation circuit is converted into low-frequency interrupted direct current and a high frequency emitted from the high-frequency oscillation circuit is converted into high-frequency interrupted direct current; and
an alternate output circuit connected to the interrupted direct current circuit such that low-frequency interrupted direct current and high-frequency interrupted direct current, which are applied, are alternately output at a predetermined time interval.

3. The scale treatment apparatus of claim 2, wherein the interrupted direct current supply unit further comprises:
a control circuit provided between the power supply circuit and the basic frequency oscillation circuit such that direct current power of the power supply circuit is variably output in a range from 5V to 15V corresponding to a magnitude of interrupted direct current for a diameter of the pipe; and
an output circuit for applying low-frequency interrupted direct current and high-frequency interrupted direct current, which are alternately output from the alternate output circuit, to the magnetic field generation unit.

4. The scale treatment apparatus of claim 3, wherein the output circuit alternately applies low-frequency interrupted direct current and high-frequency interrupted direct current, each ranging from 1 to 3 (A), to the magnetic field generation unit.

5. The scale treatment apparatus of claim 2, wherein the low-frequency oscillation circuit oscillates with a sawtooth waveform at a low frequency of 60 to 100 Hz, and the high-frequency oscillation circuit oscillates at a high frequency of 5 to 10 KHz.

6. The scale treatment apparatus of claim 2, wherein the alternate output circuit alternately outputs low-frequency interrupted direct current and high-frequency interrupted direct current at an interval of 1 to 3 sec.

7. The scale treatment apparatus of claim 1, wherein the magnetic field generation unit comprises a magnetic field generation coil wound around an outer surface of the pipe so that low-frequency interrupted direct current and high-frequency interrupted direct current are alternately applied from the interrupted direct current supply unit.

8. The scale treatment apparatus of claim 7, wherein the magnetic field generation coil is configured such that a heat-resistant insulation line is wound 20 to 28 times around the outer surface of the pipe.

9. The scale treatment apparatus of claim 7, wherein the magnetic field generation unit further comprises a fixed magnet which is fixedly provided on the outer surface of the pipe so that a fixed magnetic field is applied to the pipe.

10. The scale treatment apparatus of claim 9, wherein the magnetic field generation unit is provided to the pipe in a manner in which the fixed magnet is disposed between a pair of magnetic field generation coils.
